(19) United States
(12) Patent Application Publication
(10) Pub. No.: US 2008/0027579 A1
(43) Pub. Date: Jan. 31, 2008

(54) Dosage limiting medication dispensing method and apparatus

(76) Inventor: Roland Gerritsen van der Hoop, Glen Mills, PA (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/497,510

(22) Filed: Jul. 31, 2006

(51) Int. Cl. G06F 17/00

(52) U.S. Cl. 700/242

(57) ABSTRACT

A method for controlled release of medication comprises a dispenser for regulating the release of medication according to designated instructions and for identifying instances where the dispenser has been tampered with in connection with attempts to release additional medication above the designated instructions. In addition, a dispenser for abusable medication is structured to dispense single dosages of medication at predetermined time intervals. Access to a medication is resisted at other times, and access to more than a single dosage of medication at any given time is also resisted. The dispenser may include its own container for the medication or may be utilized in conjunction with a standard medication container. The dispenser may be structured to show visible damage in the event of tampering.

### FIELD OF THE INVENTION

The present invention relates generally to the dispensing of medications. Specifically, the invention relates to a method for the controlled dispensing of medications that provides regulated dosages of medication at predetermined time intervals, and is capable to identify tampering efforts to access the medication at other times.

### BACKGROUND

Opioids such as morphine have been a very useful and powerful class of analgesic compounds for a long time. However, the potential for addiction and abuse limits the extent to which these drugs may be safely prescribed and dispensed. Abuse is defined as any use that is not in accordance with the instructions, and includes misuse, overuse, and diversion to another individual. In the past, abuse of opioids has centered around compounds that are not approved for dispensing by prescription, and which are manufactured and distributed illegally. However, abuse of lawfully prescribed and dispensed opioids has increased, especially in the case of extended-release dosage forms. Such dosage forms provide substantially larger amounts of opioid to a potential abuser than the low-dosage, immediate release dosage forms used in the past. Such tablets may be chewed or otherwise tampered with to break the extended-release matrix, thereby releasing all of the opioid at once. Furthermore, there is evidence that abusers are developing other techniques to extract drugs from tablets.

One prior technique for avoiding abuse is to incorporate emetic into the dosage form, causing an abuser to vomit if a sufficient quantity of emetic is consumed. A single dosage does not contain sufficient emetic to induce vomiting, but taking multiple dosages at once would provide sufficient emetic to induce vomiting, thereby preventing the opioid from entering the bloodstream. Examples of such emetics include those disclosed in U.S. Pat. Nos. 4,175,119; 4,269,820; and 4,432,787. These patents fail to address the problem of abuse by crushing or otherwise tampering with a single tablet, so that all active ingredient is provided immediately to the user, because an individual tablet fails to contain enough emetic to induce vomiting.

Other patents attempt to deter abuse by incorporating an opioid antagonist into the dosage form, so that the euphoric “high” that would normally result from an overdose is resisted. Examples of such antagonists are disclosed in International Patent Application No. WO 01/58451 and U.S. Pat. No. 6,274,591. Although such opioid antagonists may be effective if a tablet is crushed and taken parenterally such as by snorting or injection, they may be less effective if a tablet is chewed and the opioid is taken orally, depending on the antagonist selected. Additionally, although opioid antagonists counteract the euphoric effect of the opioid, they do not resist the entry of opioid into the abusers' bloodstream. Resistance to the euphoric effect the opioid decreases after the antagonist leaves the abusers' system, which will require less time than the opioid leaving the abusers' system. Lastly, opioid antagonists themselves have potential side effects, raising potential ethical objections to providing a formulation that introduces potential risks without any benefit to the conscientious user.

International Patent Application No. WO 2005/018616, owned by the assignee of the present invention, discloses an emetic that is provided within a dosage in a slow-release or non-release matrix, so that a properly taken dosage will not release sufficient emetic to induce vomiting. However, chewing or crushing a tablet will release sufficient emetic to induce vomiting.

Although a modification of the dosage form itself makes it more difficult to abuse legitimately prescribed opioids, abusers may find new methods of abusing tablets and circumventing negative effects. In many instances, abusers obtain prescription opioids directly or indirectly from the patient for whom they are prescribed. An abuser may steal a few tablets from a vial, or the patient may sell part or all of a prescription to an abuser or dealer. Therefore, there is a need to regulate the number and frequency of dosages available to those prescribed such opioids, thereby further reducing a potential for abuse.

### SUMMARY OF THE INVENTION

The above-described need is met by embodiments of the present invention, which provides a method for the controlled dispensing of medications.

A method for controlled release of medication comprises a dispenser for regulating the release of medication according to designated instructions and for identifying instances where the dispenser has been tampered with in connection with attempts to release additional medication above the designated instructions.

These and other features and advantages of the invention will become more apparent through the following description and drawings.

### BRIEF DESCRIPTION OF THE DRAWINGS

For the purpose of illustrating the invention, there is shown in the drawings a form which is presently preferred; it being understood, that this invention is not limited to the precise arrangements and instrumentalities shown.

FIG. 1 is a top view of one embodiment of a dispenser according to the present invention.

FIG. 2 is a bottom view of the dispenser of FIG. 1.

FIG. 3 is a bottom view of a receptacle disk for a dispenser of FIG. 1.

FIG. 4 is a top view of an enclosure disk for a dispenser of FIG. 1.

FIG. 5 is a side cross-sectional view of a dispenser according to FIG. 1 taken along the lines 5-5 of FIG. 2.

FIG. 6 is a side elevational view of another embodiment of a dispenser according to the present invention.

FIG. 7 is a side cross-sectional view of another embodiment of a dispenser according to the present invention.

FIG. 8 is a side cross-sectional view of the dispenser of FIG. 7, showing the slider withdrawn.

FIG. 9 is a side cross-sectional view of yet another embodiment of a dispenser according to the present invention.

FIG. 10 is a side cross-sectional view of another alternative embodiment of a dispenser according to the present invention.

Like reference characters denote like elements throughout the drawings.

### DETAILED DESCRIPTION

In accordance with various embodiments of the present invention, a method includes a dispenser for medication that is structured to regulate the release of medication, thereby ensuring that a patient who is legitimately prescribed an opioid or other abusable medication has access to only the prescribed dosage. Many embodiments of the invention are tamper-evident, thereby alerting a pharmacist who is refilling the invention to any attempts to access more medication than the dispenser is set to dispense. Many embodiments of the invention are also structured to resist access to the medication by a child.

In an exemplary embodiment, a method for controlling the release of medication comprises a dispenser for regulating the release of medication in accordance with designated instructions, such as via a prescription, and with the dispenser further identifying where there has been tampering efforts to obtain addition medication above the designated instructions, such as by a visual indicator.

In accordance with an exemplary embodiment, a method can comprise the steps of receiving a prescription for medication from a first health care professional, such as a doctor or nurse, providing the prescription to a second health care professional, such as a pharmacist, filling or refilling the prescription by placing the medication within the dispenser, regulating the dispenser so that it dispenses medication according to the prescription, and identifying where the dispenser has been tampered with in connection with attempts to have the dispenser provide additional medication beyond the prescribed levels.

In accordance with another exemplary embodiment, a prescription may be filled by a doctor or other health care professional and provided to a patient in a conventional manner, such as via a “script” provided to a patient in connection with an office visit. The patient then takes the script to a pharmacist to “fill” the prescription. The pharmacist fills the prescription by placing the medication into a dispenser in accordance with an embodiment of the present invention, which provides for the controlled release of the medication, as well as a visual indication where the dispenser has been tampered with in connection with attempts to access additional medication. The dispenser operates to regulate medication delivery to the patient until the dispenser is empty according to the prescribed amounts. The patient may then take the dispenser back to the pharmacy for any allowed refills based on the prescription. Where there is no visible signs of tampering, the prescription may be refilled. However, where the pharmacist detects any visible signs of tampering, the prescription is not refilled. In certain desired embodiments, the pharmacist may then contact the prescribing doctor or a substance abuse professional to advise that the patient may require follow-up attention for possible substance abuse counseling and/or treatment.

A dispenser in accordance with certain embodiments may operate to resist access to the medication at any desired times, and resist access to more than a single dosage of medication at any given time.

In addition, a dispenser in accordance with certain embodiments may be constructed so as to be tamper resistant, so that any improper attempts to gain access to the medication will place the dispenser into a “lock-down” mode, preventing any further dispensing of medication to the patient. In certain embodiments, the dispenser once in “lock-down” mode may be constructed so that it can not be repaired, or alternatively will be required to be “reset” by a health care professional, which would have the affect of alerting the health care professional in either situation to a potential medication abuse.

In certain desired embodiments, an alert signal may be wirelessly sent by a transmitter embedded in the dispenser to a designated location, such as a substance abuse counselor, upon the detection of any attempts to tamper with the dispenser to obtain additional medication above the regulated amounts.

In some embodiments, the dispenser may be registered to an individual patient, thereby providing a means of detecting attempts by the patient to acquire medication from more than one doctor.

Further, a dispenser in accordance with certain embodiments may show visible damage when an attempt is made to access medications secured within the container, thereby alerting a pharmacist, doctor or other health care professional who refills the dispenser that the patient may be attempting to access the medication contrary to instructions.

In an exemplary embodiment, a dispenser in accordance with embodiments of the present invention may be provided to patients who may require a plurality of medications, but who may have difficulty remembering whether or not a certain medication was taken at a particular time, such as elderly patients or patients with any memory disorders, such as Alzheimer's or dementia. By providing the medication to such patients through a dispenser in accordance with embodiments of the present invention, such patients will know that taking a dosage of medication is desirable any time a dosage is made available to them by the dispenser.

As used herein, the term “abusable medication” is defined as any medication which may be prescribed by a doctor for legitimate purposes and which also has a potential for abuse. Abusable medication includes but is not limited to opioids, which are defined as codeine, dihydrocodeine, hydrocodone, hydromorphone, levorphanol, meperidine, fentanyl, methadone, morphine, oxycodone, oxymorphone, propoxyphene and pharmaceutically acceptable salts, derivatives, and analogs thereof. Abusable medication also includes anti-depressants, stimulants, sleeping aids, and similar medications. The medication is typically supplied in the form of a tablet, which is defined herein as including capsules, pills, and other solid oral dosage forms. However, some examples of the invention may be usable with a liquid dosage form. Other embodiments may dispense dosages in the form of a patch that a patient adheres to their skin, permitting medication to be absorbed through the skin. A dose or dosage is defined herein as that quantity of medication that is intended by the prescribing doctor to be taken at one time, and may include a single tablet, a predetermined number of tablets, a predetermined volume of liquid, or a patch.

The dispenser may include a timer for keeping track of the appropriate time intervals for the release of medication. As used herein, a timer is defined as any device that may be utilized to actuate a medication-release mechanism after the passage of a predetermined period of time. A medication release mechanism is defined as any mechanism that makes a dosage of medication available in response to the timer.

The dispenser may include a container for containing the medication to be dispensed, or alternatively may be structured to flip over the top opening of a standard medication container.

Another example of a dispenser according to the present invention includes a pair of disks that are rotatably secured to each other. One of the disks defines a plurality of tablet or dosage receptacles thereon. The other disk defines an opening that is structured to expose a number of receptacles corresponding to a single dosage of medication. Rotation of the second disk with respect to the first disk will thereby sequentially expose the individual dosages of medication. Rotation of one disk with respect to the other may be restricted by rotating the second disk with respect to the first disk automatically at a predetermined rotational speed. Alternatively, the dispenser may include a timer that permits rotation of one disk with respect to the other only at predetermined time intervals, resisting rotation at other times. Alternative examples include a timer which may automatically rotate one disk with respect to the other at the predetermined time intervals, or may permit manual rotation of one disk with respect to the other at or after passage of predetermined time intervals. If automatic rotation of the disks is desired, such rotation may be accomplished by an electric motor structured to rotate the disks at a predetermined speed with respect to each other, or that is actuated by the timer. Some examples of the dispenser include a means for securing the first and second disks together to resist attempts to access the medication that has not been released by the dispenser, for example, a clamp securing the first and second disks together, requiring a special tool for removal. The dispenser may be structured so that an attempt to separate the pair of disks results in visible damage to the dispenser, indicating to a pharmacist who is refilling the dispenser that an attempt was made to access the medication.

Another example of a dispenser is structured to fit over the opening of a standard medication container. The dispenser includes a medication-release mechanism, and a timer that is structured to ensure that medication may be taken only at predetermined time intervals. The timer may be structured to permit the actuation of the medication release mechanism at the predetermined time intervals, or alternatively automatically actuate the medication release mechanism at predetermined time intervals. The dispenser preferably secures to the container in a manner that resists access to the medication contained within the container, and may be structured to be visibly damaged upon an attempt to separate in the dispenser from the container, or to otherwise access the medication within the container.

The medication release mechanism may include a slider. As used herein, a slider is defined as a device having at least one receptacle for holding a single tablet or dosage of medication, with the slider being movable so that the receptacle may be sequentially placed in communication with the container, and then with the outside of the dispenser, so that a single dosage of medication is carried from the container to the outside of the dispenser. One example of a slider may be a reciprocating member that slides back and forth to alternately bring the dosage receptacle into communication with the container and then with the outside of the dispenser. Another slider may be a disk having a plurality of dosage receptacles, so that rotation of the disk sequentially brings each dosage receptacle into communication with the container, and then with the outside of the dispenser.

Alternative embodiments of the dispenser may rely on manual or automatic movement of the slider. If manual movement of the slider is desired, the timer may be structured to release the slider for movement at predetermined time intervals, and to resist movement of the slider at other times. Upon the proper time being reached, the slider may be released until the slider is moved to remove the dosage, with the new time interval beginning at this time. Alternatively, the slider may be released only at this time interval. If automatic movement of the slider is desired, the timer may actuate a motor that is operatively connected to the slider at predetermined time intervals.

Various embodiments of the present invention provide a dispenser for medication that is structured to release a single dose of medication at a predetermined time interval.

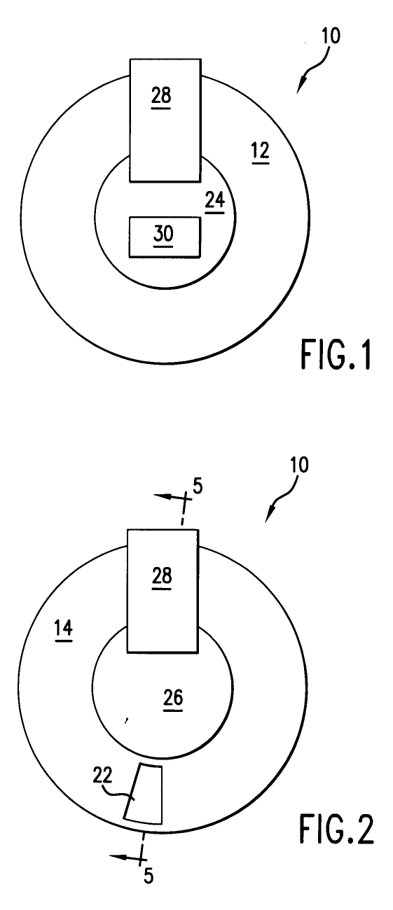

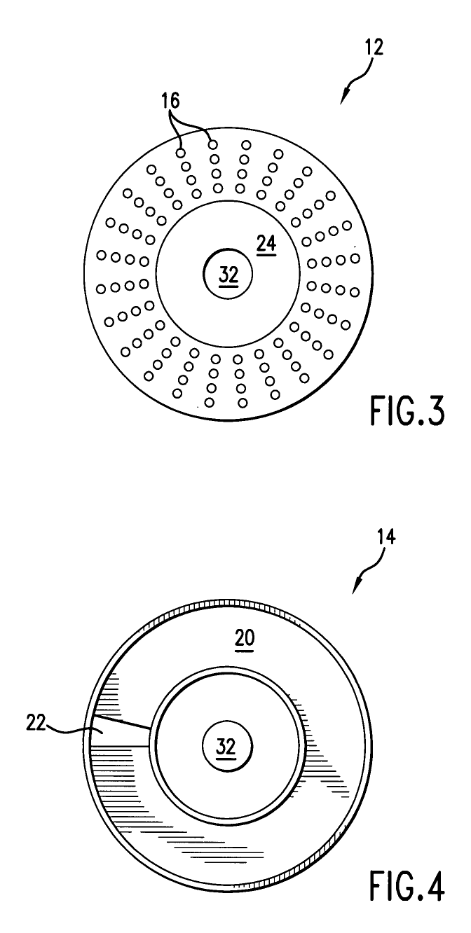

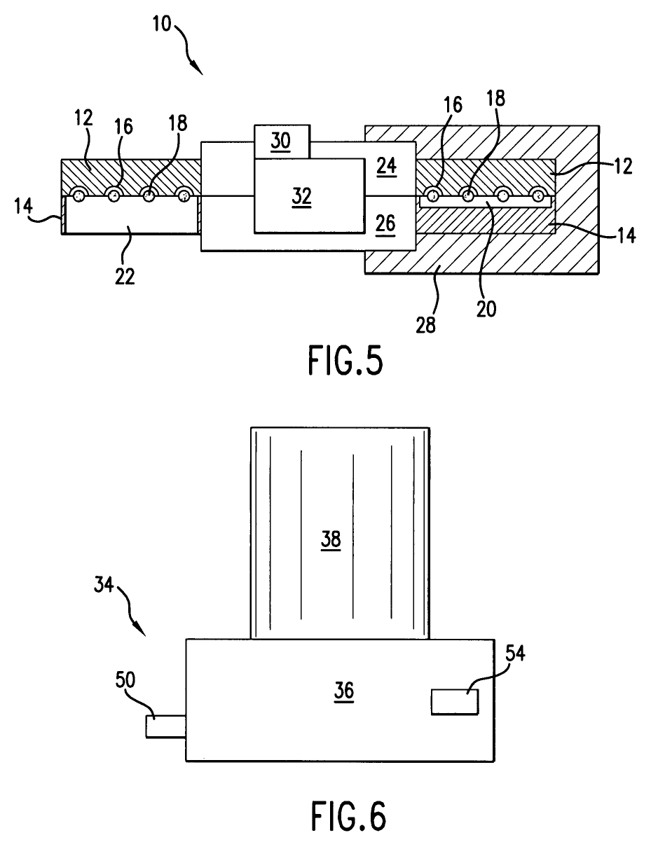

Referring to FIGS. 1-5, one embodiment of a dispenser 10 is illustrated. The dispenser 10 includes a receptacle disk 12 and enclosure disk 14 rotatably secured to each other. The receptacle disk 12 defines a plurality of receptacles 16, with each receptacle being structured to contain a single tablet 18 therein. In the illustrated example, each radially aligned row of four receptacles 16 corresponds to one dose, although a different number of receptacles 16 may be selected to correspond to a single dose, or alternatively a single receptacle 16 may contain all of the tablets 18 corresponding to a single dose.

The enclosure disk 14 may include a recess 20 defined about its periphery, and corresponding to the receptacles 16, so that each of the tablets 18 are contained within one receptacle 16 and the recess 20. The enclosure disk also defines a slot 22 structured to expose a single row of receptacles 16.

The receptacle disk 12 and enclosure disk 14 may each define a central portion 24, 26, respectively. The central portions 24, 26 are structured to be secured together in a manner that permits rotation of the receptacle disk 12 with respect to the enclosure disk 14. Some examples include a clamp 28 structured to secure the central portions 24, 26 together, and which may in some examples be removable only using a special tool that is available to pharmacists. Alternatively, the dispenser may come to the pharmacy pre-assembled in a manner that resists opening the dispenser by the pharmacist.

A timer 30 and rotation mechanism 32 that is operatively connected to the timer 30 are disposed within the central portions 24, 26. The timer 30 controls the rotation mechanism 32 so that the slot 22 aligns with each row of receptacles 16 corresponding to a single dosage of tablets 18 at predetermined time intervals. A single row of receptacles 16 therefore becomes exposed by the slot 22 only at appropriate times for taking a dosage of medication, with the remaining receptacles 16 remaining covered by the enclosure disk 14. The rotation mechanism 32 may be one which rotates at a predetermined speed so that each row of receptacles 16 is sequentially exposed at the appropriate time. Alternatively, the rotation mechanism 32 may be an electric motor that is actuated only at appropriate time intervals, rotating the receptacle disk 12 and enclosure disk 14 relative to each other only at predetermined time intervals, while resisting rotation at other times. As another alternative, the rotation mechanism 32 may be a mechanism that simply blocks rotation of the receptacle disk 12 and enclosure disk 14 relative to each other except at appropriate time intervals, at which point the rotation mechanism 32 will permit rotation of the receptacle disk 12 and enclosure disk 14 with respect to each other only enough to expose the next row of receptacles 16.

The dispenser 10 may be structured so that the receptacle disk 12 and enclosure disk 14 may be rotated one increment with respect to each other at any time after a predetermined time interval, with rotation being stopped and the timer being reset as soon as the disks 12, 14 are rotated one increment with respect to each other. Alternatively, the disks 12, 14 may be permitted to rotate with respect to each other only at predetermined time intervals, resisting rotation of the disks 12, 14 with respect to each other any time except at the predetermined time interval.

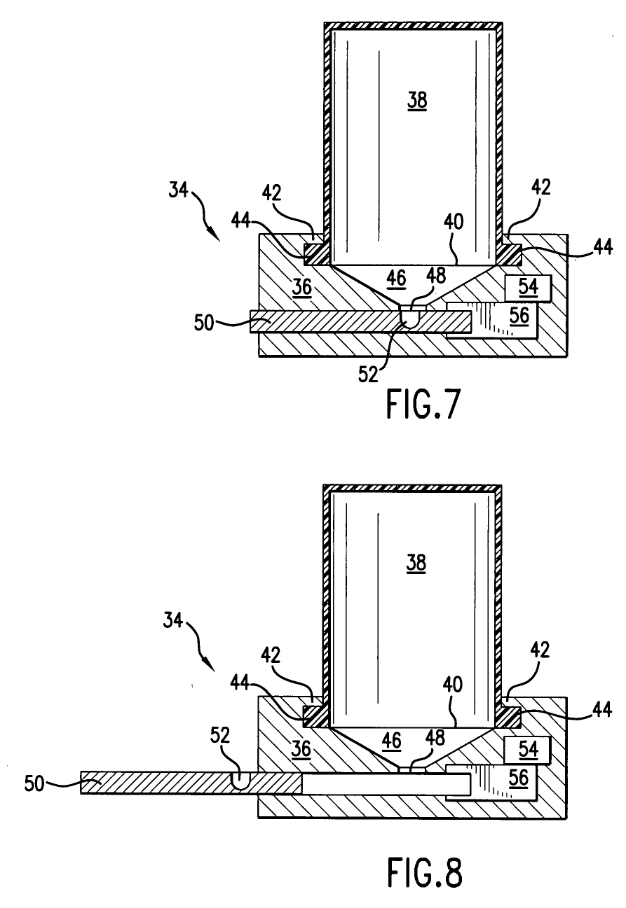

Referring to FIG. 6, another embodiment of a dispenser 34 is illustrated. The dispenser 34 differs from the dispenser 10 in that, while the dispenser 10 is intended to store the medication within the dispenser 10, the dispenser 34 includes a housing 36 that is structured to be secured over the top opening 40 of a standard medication container 38. Referring briefly to FIG. 7, the housing 36 has been secured over the top opening 40 of the medication container 38 through a locking means 42 on the housing 36 that is secured around the tabs 44 on the container 38, which would normally be used to secure a child-resistant cap to the container 38. When a container 38 is inverted so that the top opening of the container 38 and the dispenser 34 are disposed below the container 38, medication will flow into the dispenser 34, where it may be dispensed in a controlled manner.

Referring to FIG. 7, one example of a medication release mechanism for a dispenser 34 is illustrated in greater detail. As can be seen in FIG. 7, the housing 36 has been secured over the top opening 40 of the medication container 38 through a locking wheels 42 on the housing 36 that are secured around the tabs 44 on the container 38, which would normally be used to secure a child-resistant cap to the container 38. Medication is permitted to fall through the funnel 46 defined within the dispenser 34, passing through a bottom opening 48. A slider 50 is reciprocally mounted underneath the funnel 46, so that it may reciprocate between a withdrawn position illustrated in FIG. 7, and an extended position illustrated in FIG. 8. The slider 50 defines a dosage receptacle 52 therein, in a location on the slider 50 that will place the dosage receptacle 52 underneath the bottom opening 48 of the funnel 46 when the slider 50 is in its withdrawn position of FIG. 7. Extending the slider 50 to the extended position of FIG. 8 exposes the dosage receptacle 52 to the outside of the dispenser 34, thereby providing the patient with access to medication contained within the dosage receptacle 52. The dosage receptacle 52 may be structured to receive the correct quantity of medication for a single dose, which may be a single tablet or a plurality of tablets, for example.

The dispenser 34 includes a timer 54 that is operatively connected to a slider control mechanism 56. When the timer 54 indicates that a predetermined time interval has passed, the slider control mechanism 56 may either release the slider 50 for a manual movement, or may automatically move the slider 50, for example, through an appropriate motor and gear system. After a single extension/retraction cycle of the slider 50, the slider control mechanism 56 will again resist movement of the slider 50 until the next predetermined time interval passes.

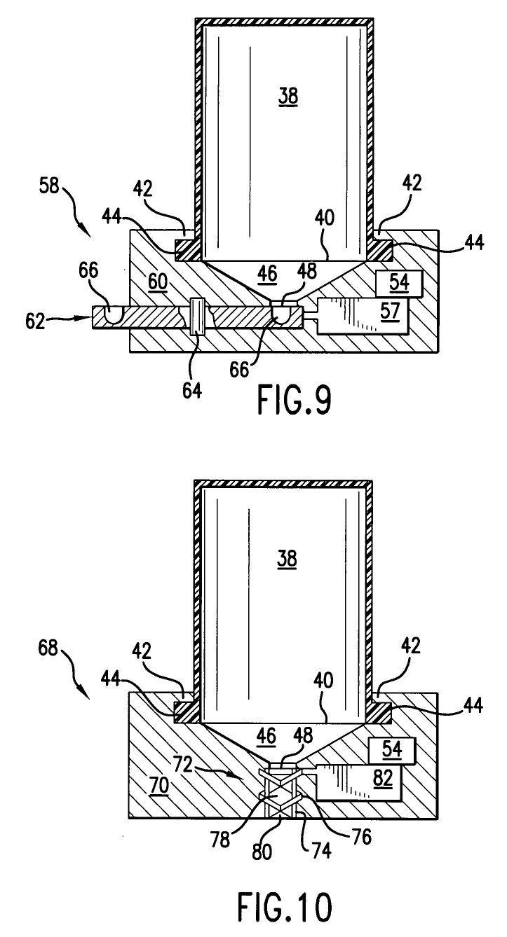

Referring to FIG. 9, another example of a dispenser 58 is illustrated. The dispenser 58 includes a housing 60 that includes a locking means 42 for securing around the tabs 44 of the container 38. A funnel 46 is disposed under the top opening 40 of the inverted container 38, leading to a bottom opening 48. An alternative slider 62 is disposed below the bottom opening 48.

The illustrated slider 62 is a disk that is pivotally mounted within the housing 60 at pivot 64. The slider 62 defines a plurality of dosage receptacles 66 about its periphery. Each dosage receptacle 66 is structured to receive a quantity of medication that is equal to a single dose, which may be, for example, a single tablet or plurality of tablets. The slider 62 is structured so that at least one dosage receptacle 66 is always exposed to the outside of the dispenser 58, and another dosage receptacle 66 is disposed underneath the opening 48 of the funnel 46. Movement of the slider 62 is controlled by a timer 54 that is operatively connected to a slider control mechanism 57. The slider control mechanism 57 resists rotation of the slider 62 at all times except when the timer 54 indicates that a predetermined time interval has passed. Upon passage of the appropriate time interval, the slider control mechanism 57 will either permit indexing of the slider 62, or will automatically index the slider 62, so that both the dosage receptacle 66 underneath the opening 48, and the dosage receptacle 66 exposed to the outside of the dispenser 58, are each replaced by an adjacent dosage receptacle 66. Additional movement of the slider 62 is resisted until the next predetermined time interval has passed. In this manner, each dosage receptacle 66 receives a dosage of medication from the container 38, and is then indexed towards a position outside of the dispenser 58. Each indexing of the slider 62 brings a dosage receptacle 66 that was previously filled from the container 38 to a position outside the dispenser 58, where it may be accessed by a patient.

The dispenser 58 may be structured to permit rotation of the slider 62 at any time after the passage of a predetermined time interval, resisting movement and resetting the timer 54 after indexing of the slider 62. Alternatively, the dispenser 58 may permit rotation of the slider 62 only at the predetermined time interval.

FIG. 10 illustrates another example of a dispenser 68 for use with a standard medication container 38. The dispenser 68 includes a housing 70 including locking members 48 for securing the dispenser 68 over the top 40 of a medication container 38. A dispenser includes a funnel 46 with a bottom opening 48 disposed below the top of the inverted container 38.

A screw drive mechanism 72 is disposed the opening 48 of the funnel 46. The screw drive mechanism 72 includes at least one screw drive 74 disposed so that its threads 76 protrude into a channel 78 leading from the opening 48 to an exit 80. In the illustrated example, a pair of screw drives 74 are illustrated. The threads 76 of the screw drives 74 resist the passage of tablets from the container 38 through the passage 78 at all times when dispensing medication is not desired.

A timer 54 is operatively connected to a screw drive controller 82, structured to turn the screw drives 74 upon being actuated by the timer 54. When a predetermined time interval has passed, the screw drive 74 will be turned so that the threads 76 push a predetermined number of tablets from the opening 48 through the passage 78, and to the exit 80. Upon dispensing a predetermined number of tablets, the screw drive 74 will be stopped, so that the threads 76 will again resist the passage of medication through the channel 78.

The dispenser 68 may be structured to permit rotation of the screw drive mechanism 72 at any time after the passage of a predetermined time interval, resisting movement and resetting the timer 54 after rotation of the screw drive mechanism 67. Alternatively, the dispenser 68 may permit rotation of the screw drive mechanism 72 only at the predetermined time interval.

While a specific embodiment of the invention has been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. A method for controlled release of medication comprising the steps of:
providing a dispenser for regulating the release of medication according to designated instructions and for identifying instances where the dispenser has been tampered with in connection with attempts to release additional medication above the designated instructions.

2. A method according to claim 1, wherein the designated instructions comprises a prescription.

3. A method according to claim 1, wherein the step of identifying instances where the dispenser has been tampered with comprises a visual indication.

4. A method for regulating the dispensing of medication comprising the steps of:
receiving a prescription for medication from a first health care professional, with the prescription designating requirements as to patient use of the medication; and
receiving medication from a second health care professional, with the medication being provided in a dispenser that regulates the release of medication in accordance with requirements of the prescription and which visually displays when there has been tampering in accordance with attempts to obtain additional medication beyond the requirements of the prescription.

5. A method according to claim 4, further comprising the step of:
permitting the dispenser to be refilled with additional medication as may be allowed in accordance with the prescription when there is no visual indication of tampering, and
denying the dispenser to be refilled when there is visual indication of tampering.

6. A dispenser for abusable medication, the dispenser comprising means for releasing a single dosage of medication at preselected time intervals, and for resisting releasing additional medication.

7. The dispenser according to claim 6, further comprising a timer operatively connected to the means for releasing a single dosage of medication at preselected time intervals.

8. The dispenser according to claim 6, further comprising a container in communication with the means for releasing a single dosage of medication at preselected time intervals, the container being structured to store the medication.

9. The dispenser according to claim 7, wherein the dispenser comprises:
a first disk defining a plurality of dosage receptacles therein;
a second disk rotatably secured to the first disk, the second disk defining an opening therein corresponding to a single dosage receptacle; and
the means for releasing a single dosage of medication at preselected time intervals are selected from the group consisting of:
means for rotating the second disk with respect to the first disk at a predetermined rotational speed;
means for rotating the second disk with respect to the first disk at predetermined time intervals; and
means for permitting the rotation of the second disk so that the opening in the second disk is indexed from one dosage receptacle to another dosage receptacle at predetermined time intervals.

10. The dispenser according to claim 6, wherein the means for rotating the second disk with respect to the first disk include a motor.

11. The dispenser according to claim 10, wherein the motor is structured to rotate the second disk at a predetermined rate so that each dosage receptacle is exposed by the opening defined within the second disk at a predetermined time interval.

12. The dispenser according to claim 10, further comprising a timer operatively connected with the motor, the timer being structured to actuate the motor at predetermined time intervals and for a time sufficient to advance the opening defined in the second disk from one dosage receptacle to an adjacent dosage receptacle.

13. The dispenser according to claim 9, further comprising a timer operatively connected to a means for selectively permitting or resisting indexing of the second wheel so that the opening defined within the second wheel moves from one dosage receptacle to an adjacent dosage receptacle, the timer being structured to permit indexing of the second wheel only after a predetermined time interval since a previous indexing of the second wheel.

14. The dispenser according to claim 9, wherein the dispenser is structured to be visibly damaged upon an attempt to separate the first disk from the second disk.

15. The dispenser according to claim 14, further comprising a clamp secured to one of the disks, the clamp being structured to fit around the other of the disks to secure the disks together.

16. The dispenser according to claim 6, wherein the dispenser is structured to be secured over an opening defined in a medication container.

17. The dispenser according to claim 16, wherein the means for releasing a single dosage of medication at preselected time intervals includes:
a medication release mechanism; and
a timer operatively connected to the medication release mechanism, the timer being structured to permit or actuate the medication release mechanism at predetermined time intervals, and to resist releasing additional medication.

18. The dispenser according to claim 17, wherein the medication release mechanism includes a slider, the slider being structured to move between a first position wherein a dosage receptacle defined within the slider is in communication with an interior of the container and not with an exterior of the dispenser, and a second position wherein the dosage receptacle defined within the slider is in communication with the exterior of the dispenser and not with the interior of the container.

19. The dispenser according to claim 18, wherein the slider includes a single dosage receptacle that moves between the first position and second position each time the dispenser is actuated.

20. The dispenser according to claim 18, wherein the slider includes a plurality of dosage receptacles, each of which is sequentially placed in communication with the interior of the container when the slider is indexed, the slider further being structured so that subsequent indexing of the slider brings a dosage receptacle that was previously in communication with the interior of the container into communication with the exterior of the dispenser.

21. The dispenser according to claim 18, wherein the slider is structured to translate between the first position and the second position.

22. The dispenser according to claim 18, wherein the slider is pivotally secured within the dispenser, and is structured to rotate between the first position and the second position.

23. The dispenser according to claim 17, further comprising a motor operatively connected between the timer and the medication release mechanism, the motor being structured to actuate the medication release mechanism in response to a signal from the timer.

24. The dispenser according to claim 16, further comprising a means for selectively permitting or resisting actuation of the medication release mechanism operatively connected with the timer; whereby actuation of the medication release mechanism by the patient is permitted at preselected time intervals and resisted at other times.

25. The dispenser according to claim 16, wherein the dispenser is structured to be visibly damaged upon an attempt to remove the dispenser from the container.

26. The dispenser according to claim 6, wherein the dispenser is structured to incur visible damage upon an attempt to access medication within a container from which the dispenser dispenses medication.

27. A method of dispensing medication, comprising:
providing a medication;
providing a dispenser structured to dispense a single dosage of medication at predetermined time intervals and to resist dispensing additional medication; and
incrementally dispensing single dosages of the medication from the dispenser at predetermined time intervals.

28. The method according to claim 27, wherein incrementally dispensing single dosages of the medication is performed by sequentially permitting access to single dosage receptacles defined within the dispenser.

29. The method according to claim 27, wherein incrementally dispensing single dosages of the medication is performed by transporting a single dosage of medication from a container to an exterior of the dispenser.

30. The method according to claim 27, further comprising providing evidence of tampering in the event that tampering with the dispenser occurs.

31. The method according to claim 30, wherein the evidence of tampering is visual evidence.

32. A method of identifying patients at risk for abusing medication, the method comprising:
providing a dispenser to the patient, the dispenser having a first quantity of medication secured therein, the dispenser being structured to release single dosages of medication at predetermined time intervals and to resist releasing medication at other times;
providing the dispenser with a means for evidencing tampering with the dispenser; and
inspecting the dispenser prior to providing a second quantity of medication to the patient.

33. The method according to claim 32, further comprising collecting information about evidence of tamper with the dispenser.

34. The method according to claim 33, further comprising analyzing the information to determine whether the patient is at risk of abusing the medication.

35. The method according to claim 32, further comprising informing a physician prescribing the medication about any evidence of tampering.

36. A method of identifying potential medication abuse, the method comprising:
providing a dispenser adapted to contain a quantity of medication, the dispenser being capable to regulate the manner by which the medication is to be taken by a patient according to designated instructions, the dispenser further being capable to evidence tampering by the patient or other persons, wherein the tampering is an indicator that medication may have been taken, or attempted to be taken, in a manner contrary to the designated instructions;
filling the dispenser with a first quantity of medication; and
inspecting the dispenser at designated times to identify evidence of tampering.

37. The method according to claim 36, wherein the designated times comprises when the dispenser is to be filled with a second quantity of medication.

38. The method according to claim 37, wherein the inspecting is performed at a pharmacy by a pharmacist or technician.

39. The method according to claim 36, further comprising informing a health care professional about any evidence of tampering.

40. The method according to claim 39, wherein the health care professional comprises a physician that prescribed the medication.

41. The method according to claim 36, wherein the designated instructions comprises a prescription.

42. The method according to claim 39, further comprising analyzing the information to determine whether the patient is at risk of abusing the medication.

43. The method according to claim 36, wherein the dispenser being capable to regulate the manner by which the medication is to be taken by a patient comprises one or more selected from the group consisting of dosage of medication to be taken by the patient and frequency by which the medication is to be taken by the patient.

44. The method according to claim 36, wherein the dispenser being capable to regulate the manner by which the medication is to be taken further comprises releasing medication at certain designated times and resist releasing medication at other times.
